(19) United States
(12) Patent Application Publication
(10) Pub. No.: US 2023/0303784 A1
(43) Pub. Date: Sep. 28, 2023

(54) PROCESS FOR PRODUCING A NON-FLAT ARTICLE

(71) Applicant: PLANTICS HOLDING B.V., AV Arnhem (NL)

(72) Inventors: Wridzer Jan Willem BAKKER, Arnhem (NL); Mathieu Baptiste ROUAUD, Arnhem (NL)

(73) Assignee: PLANTICS HOLDING B.V., Arnhem (NL)

(21) Appl. No.: 18/038,162

(22) PCT Filed: Nov. 23, 2021
(86) PCT No.: PCT/EP2021/082694

§ 371 Date: May 22, 2023

(30) Foreign Application Priority Data
Nov. 23, 2020 (EP) 20209317.5

(51) Int. Cl. C08J 5/04; C08G 63/16; C08J 5/24

(52) U.S. Cl. CPC C08J 5/045; C08J 5/043; C08G 63/16; C08J 5/245; C08J 5/244; C08J 2367/02

(57) ABSTRACT

The invention relates to a process for manufacturing a nonflat article comprising the steps of providing a structure comprising a fibrous material and a resin comprising a polymer derived from an aliphatic polyalcohol with 2-15 carbon atoms and an aliphatic polycarboxylic acid that has an extent of polymerization of above 0 to 1.0, or the precursor monomers of such polymer, wherein the structure has a void fraction of 0.3-0.98 and a water content of below 40 wt. %; and subjecting the structure to the following steps polymerising to an extent of polymerisation of 0.5-1, if necessary, pressing to reduce void fraction, and forming the structure into a non-flat article by applying a force at an internal temperature above glass transition temperature (T_{g}) of the polymer in a defined order to form a non-flat article having an extent of polymerisation of at least 0.5 and a water content less than 20 wt. %. The invention also relates to non-flat articles obtainable by the process and structures suitable for use in the process.

The present invention pertains to a process for producing an article from a fibrous material, e.g., a bio-based fibrous material, and a resin comprising a polymer. The articles so obtained are surprisingly strong and scratch-resistant, and can be formed into non-flat shapes. The invention also pertains to the articles obtainable by the process and structures for use in the process.

Various methods for producing articles from bio-based materials are known in the art. These articles are desired for reasons of sustainability.

WO 2012/140237, for example, describes methods for manufacturing a composite material comprising 10-98 wt. % of a bio-based particulate or fibrous filler and at least 2 wt. % of a polyester, wherein the method comprises combining the filler and the polyester (or a precursor thereof), and subjecting the combination to a curing step.

WO 2012/140238 describes a method for manufacturing laminates. A carrier is coated with a layer of a polyester. The composite is then cured to give a laminate. Using this approach, stacks of wood could be glued together.

There is increased interest in the market, in particular in the fields of furniture, transportation (e.g. the automotive industry) and construction, in articles derived from renewable resources, in particular from bio-based resources. Of course, in addition to be derivable from renewable resources, the articles should also meet other requirements. They should combine an attractive natural look and feel with good strength and durability properties, including, e.g., a good scratch resistance, and good resistance to repeated application of force, e.g., as evidenced by meeting the requirements of the applicable European norms.

Additionally, it should be possible to manufacture articles with almost any shape, including complex shapes. These include pieces of furniture (e.g. chairs, (bar)stools, and sofas), non-flat articles for construction, and non-flat articles for the transportation (e.g. automotive) industry (e.g. panels in car doors). Natural materials conventionally used, such as wood, generally do not have a desired formability.

The present invention pertains to a process that solves these problems. It enables the production of articles having a structurally complex (e.g., non-flat) shape, which articles have a good (natural) look and feel, high strength, and good durability properties, as discussed above, and which can be obtained from renewable resources. This process is disclosed herein.

The invention pertains to a process for manufacturing a non-flat article comprising the steps of:
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, or the precursor monomers of such polymer, wherein the structure has a void fraction of 0.3-0.98 and a water content of below 40 wt. %, and
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 20 wt. %,
wherein polymerisation (if carried out), reduction of void fraction, and forming are carried out simultaneously, or
wherein polymerisation (if carried out) and reduction of void fraction are carried out simultaneously, followed by forming, or
wherein polymerisation (if carried out) and reduction of void fraction are carried out sequentially in any order, followed by forming, or
wherein polymerisation (if carried out) is followed by reduction of void fraction and forming, with forming being carried out simultaneously with void fraction reduction or subsequent thereto.

Surprisingly, this process enables the manufacture of non-flat articles with almost any shape. The composition of the structure—the starting material in the process according to the invention—was found to be particularly important. Specifically, the use of a fibrous material, in particular a non-woven fibrous material, with a high void fraction was found to be advantageous, as the fibers in such a material have some freedom to move relative to each other. As a result, the fibrous material can adopt almost any shape, which shape is stabilised by the polymer in the resin. In addition, fibrous materials with a high void fraction are easier to impregnate with resin than fibrous materials with a low void fraction. This leads to better adhesion of the fibers and so to a stronger end product. Moreover, advantageously, when the water content of the structure is less than 20 wt. % and the extent of polymerisation of the polymer is at least 0.5, the waste of resin is reduced and the time required for forming the structure is decreased. Accordingly, by selecting the extent of polymerisation and water content as defined herein, the impact on the environment due to unnecessary energy consumption and waste of the starting materials was reduced. This also allows the structures to be shipped as ready-to-use starting materials for the manufacture non-flat articles, which facilitates the manufacture of non-flat articles with a low environmental impact.

The process is disclosed in more detail below. Specific advantages of the process and specific embodiments thereof will become apparent from the further specification.

### The Fibrous Material

The starting material in the process as described herein is a structure comprising a fibrous material and a resin.

The structure used in the process of the invention comprises one or more layers of fibrous material. In one embodiment, the structure comprises a single layer of fibrous material. In another embodiment, the structure comprises more than one layer of fibrous material, for example 2 to 10 layers, preferably 3 to 6 layers. The layers of fibrous material may be woven or non-woven layers. Preferably, the layers of fibrous material are non-woven layers, because these are easier to form. When the layers of fibrous material are woven layers, it may be desirable to use more than one layer of fibrous material. Within the context of the present specification, the word “fiber” refers to monofilaments, multifilament yarns, threads, tapes, strips, and other elongate objects having a regular or irregular cross-section and a length substantially longer than the width and thickness.

The presence of fibrous material in the structure is important, as it provides shapeability, strength, and volume to the structure. It will be understood the fibrous material used in the process of the invention is flexible and capable of being subjected to high pressures without detrimentally affecting the fiber properties. In addition, the fibrous material may also give specific properties to the end product, such as a desirable look and feel or a particular texture.

The structure has a good shapeability, at least in part because the fibrous material used therein has a defined void fraction. The fibrous material (not containing the resin) generally has a void fraction of at least 0.4, in particular at least 0.5, more in particular at least 0.6, even more in particular at least 0.7, still more in particular at least 0.8. As a general upper limit, a value of at most 0.98 may be mentioned. A void fraction reflects the volume of voids in a material (which may be filled with a gas, e.g. air) over the total volume of the material. So, the void fraction of the fibrous material can be calculated from the density of the fibrous material itself and the density of the materials making up the fibrous material (i.e., the density of hemp, when the fibrous material is a hemp layer).

In a non-woven fibrous material, the fibrous material generally has a fiber length, determined over its longest axis, of 0.5-10 cm. Preferably, the fibrous material has a fiber length of 1-10 cm. More preferably, the fibrous material has a fiber length of 2-7 cm. In a woven fibrous material, the fiber length generally is of the order of the length and width of the material. For example, when a woven fibrous material is used to manufacture a seat for a chair, the fibers in one direction may have a length which corresponds to the length of the seat, while the fibers in the other direction may have a length which corresponds to the width of the seat.

The fibrous material may comprise plant-derived fibers, preferably cellulosic and/or lignocellulosic fibers. The fibrous material may also consist essentially of plant-derived fibers. Examples of fibers based on plant-derived fibers include flax, hemp, kenaf, jute, ramie, sisal, coconut, and cotton. The fibrous material may also comprise an animal-derived fiber. The animal-derived fiber may be wool, hair, silk, and fibers derived from feathers (e.g., chicken feathers). Other parts of offal may also be used.

The fibrous material may comprise synthetic fibers. Examples of suitable synthetic fibers are fibers derived from viscose, glass, polyesters, carbon, aramids, nylons, acrylics, polyolefins and the like. The fibrous material may also be a mixture of fibers of different origin, such as a mixture of plant-derived fibers and synthetic fibers.

The one or more layers of fibrous material generally are in the form of sheets (e.g. a fiber mats). The fibers in these sheets are oriented in a random (e.g., a non-woven sheet) or a non-random manner. In the context of the present specification “oriented in a non-random manner” refers to all structures wherein fibers are oriented with respect to each other in an essentially regular manner. Examples of sheets containing fibers oriented in a non-random manner include woven layers, knitted layers, layers wherein the fibers are oriented in parallel, and any other layers wherein fibers are connected to each other in a repeating patters.

Fiber orientation in the layers of fibrous material can, for example, affect the strength of the end-product (i.e., the article obtainable by the process according to the invention). Therefore, it may be preferred to orientate the fibers in a manner that maximises the strength of the article. In some embodiments, at least 50% of the fibers are oriented in parallel, preferably at least 60% of the fibers are oriented in parallel, more preferably at least 70% of the fibers are oriented in parallel. For example, if the article is a seat for a chair, the fibers may be oriented from the tip of the seat to the top of the backrest. In other cases, more anisotropic properties or bi-directional resistance may be required. The fibers may then be oriented in two or more directions. Combinations of different layer structures may also be used.

### The Resin

The structure used in the process of the invention also comprises a resin comprising a polymer derived from an aliphatic polyalcohol with 2-15 carbon atoms and an aliphatic polycarboxylic acid having 3 to 15 carbon atoms.

The aliphatic polyalcohol does not comprise any aromatic moieties, nitrogen atoms or sulphur atoms. In some embodiments, the aliphatic polyalcohol consists essentially of carbon, oxygen and hydrogen atoms. The aliphatic polyalcohol comprises at least two hydroxyl groups, preferably at least three hydroxyl groups. In general, the number of hydroxyl groups will be 10 or fewer, preferably 8 or fewer, more preferably 6 or fewer.

The aliphatic polyalcohol has 2 to 15 carbon atoms, preferably 3 to 10 carbon atoms. Examples of suitable aliphatic polyalcohols are 1,2-propane diol, 1,3-propane diol, 1,2-ethane diol, glycerol, sorbitol, xylitol, and mannitol. Glycerol, sorbitol, xylitol, and mannitol are preferred examples of suitable aliphatic polyalcohols. Glycerol is the most preferred example of a suitable aliphatic polyalcohol. This is because glycerol has a melting point of 20° C., which allows easy processing (compared to, e.g., xylitol, sorbitol, and mannitol, which all have melting points above 90° C.). Moreover, glycerol is easily accessible and results in polymers having desirable properties. Accordingly, in some embodiments, the aliphatic polyalcohol consists essentially of glycerol. As used herein, “consists essentially of” means that other components (here: other aliphatic polyalcohols) may be present in amounts that do not affect the properties of the material.

Mixtures of different aliphatic polyalcohols may also be used. The aliphatic polyalcohol may comprise at least 50 mol % of glycerol, sorbitol, xylitol, or mannitol, preferably at least 70 mol %, preferably at least 90 mol %. Preferably, the balance is an aliphatic polyalcohol having 3 to 10 carbon atoms. The polyalcohol preferably comprises at least 70 mol % of glycerol, preferably at least 90 mol %, more preferably at least 95 mol %.

In some embodiments, the aliphatic polyalcohol has a ratio of hydroxyl groups over the number of carbon atoms from 1:4 (i.e., one hydroxyl group per four carbon atoms) to 1:1 (i.e., one hydroxyl group per carbon atom). It is preferable for the ratio of hydroxyl groups over the number of carbon atoms to be from 1:3 to 1:1, more preferably from 1:2 to 1:1, still more preferably from 1:1.5 to 1:1. Compounds wherein the ratio of hydroxyl groups to carbon atoms is 1:1 are considered especially preferred.

The aliphatic polycarboxylic acid has 3 to 15 carbon atoms, preferably 3 to 10 carbon atoms. The aliphatic polycarboxylic acid does not comprise aromatic moieties, or any nitrogen or sulphur atoms. In some embodiments, the aliphatic polycarboxylic acid consists of carbon, oxygen and hydrogen atoms. The aliphatic polycarboxylic acid comprises at least two carboxylic acid groups, preferably three carboxylic acid groups. In general, the number of carboxylic acid groups will be 10 or fewer, preferably 8 or fewer, more preferably 6 or fewer.

In particular, the aliphatic polycarboxylic acid comprises at least 10 wt. % of tricarboxylic acid, calculated on the total amount of aliphatic polycarboxylic acid. The aliphatic polycarboxylic acid may comprise at least 30 wt. % of tricarboxylic acid, calculated on the total amount of acid, preferably at least 50 wt. %, more preferably at least 70 wt. %, still more preferably at least 90 wt. %, most preferably 95 wt. %. In some embodiments, the aliphatic polycarboxylic acid consists essentially of tricarboxylic acid, preferably essentially of citric acid.

The tricarboxylic acid, if used, may be any tricarboxylic acid which has three carboxylic acid groups and, in general, at most 15 carbon atoms. Examples include citric acid, isocitric acid, aconitic acid (both cis and trans), and 3-carboxy-cis,cis-muconic acid. The use of citric acid is considered preferred, both for reasons of costs and of availability.

The dicarboxylic acid, if used, may be any dicarboxylic acid which has two carboxylic acid groups and, in general, at most 15 carbon atoms. Examples of suitable dicarboxylic acids include itaconic acid, malic acid, succinic acid, glutaric acid, adipic acid, sebacic acid and oxalic acid. Itaconic acid and succinic acid may be preferred. In one embodiment a tricarboxylic acid is used.

The aliphatic polycarboxylic acid may be a mixture of acids, such as a mixture of tricarboxylic acid(s) and dicarboxylic acid(s). In some embodiments, the aliphatic polycarboxylic acid comprises a combination of at least 2 wt. %, preferably at least 5 wt. %, more preferably at least 10 wt. % dicarboxylic acid and at least 10 wt. %, preferably at least 30 wt. %, more preferably at least 70 wt. %, still more preferably at least 90 wt. %, most preferably at least 95 wt. % tricarboxylic acid, calculated on the total amount of aliphatic polycarboxylic acid.

The aliphatic polyalcohol and the aliphatic polycarboxylic acid used in the process according to the invention can react to form polymers.

The polymer can be obtained by combining the polyalcohol and the polycarboxylic acid (and, optionally, a polymer derived from polyalcohol and polycarboxylic acid) to form a liquid phase and, if necessary, curing the obtained liquid phase. Depending on the nature of the compounds this can be done, e.g., by heating a mixture of components to a temperature where the acid will dissolve in the alcohol, in particular in glycerol. Depending on the nature of the compounds the temperature may be, e.g., a temperature in the range of 20° C. to 200° C., preferably 40° C. to 200° C., more preferably 60° C. to 200° C., most prefera bly 90° C. to 200° C. In some embodiments, the combination may be heated and mixed for a period of 5 minutes to 12 hours, preferably 10 minutes to 6 hours, at a temperature of 100° C. to 200° C., preferably 100° C. to 150° C., more preferably at a temperature in the range of 100° C. to 140° C. The polymer is preferably obtained by curing at a temperature of at most 140° C.

Optionally, a suitable catalyst can be used for the preparation of the polymer. Suitable catalysts for the manufacture of polymer are known in the art. Preferred catalysts are those that do not contain heavy metals. Useful catalysts are strong acids such as, but not limited to, hydrochloric acid, hydroiodic acid and hydrobromic acid, sulfuric acid (H₂SO₄), nitric acid (HNO₃), chloric acid (HClO₃), boric acid, perchloric acid (HClO₄), trifluoroacetic acid, para-toluenesulphonic acid, and trifluoromethanesulfonic acid. Boric acid may be preferred. Catalysts like Zn-acetate and Mn-acetate can also be used, but may be less preferred.

Optionally, after polymerization and cooling of the reaction mixture, the mixture can be (partially) neutralized with a volatile base like ammonia or an organic amine to stabilize the polymer solution. Preferred organic amines are amines with a low odour, such as, but not limited to, 2-amino-2-ethyl-1,3-propanediol, 2-amino-2-methyl-1-propanol, and 2-dimethylamino-2-methyl-1-propanol.

Depending on the reaction conditions, when newly obtained, a polymer derived from the aliphatic polyalcohol and the aliphatic polycarboxylic acid may have an extent of polymerization between 0.10 and 0.60, preferably between 0.20 and 0.60, more preferably between 0.30 and 0.60. In the present specification, the “extent of polymerization” is the ratio of the fraction of functional groups that have reacted at a certain point in time to the maximum of the functional groups that can react. For example, if no monomers have reacted, the extent of polymerization is 0. The extent of polymerization can be determined by comparing the acid value of the reaction mixture to the theoretical acid value of the total of the monomers present. This method may be preferred if, from a visual inspection, the extent of polymerization appears to be ≤0.5. Alternatively, the extent of polymerization can be determined using gravimetric analysis (from the water loss that occurs during the polymerization reaction). This method may be preferred if, from a visual inspection, the extent of polymerization appears to be >0.5.

If desired, the resin can be diluted to control the viscosity of the resin. For example, the resin can be diluted with water. This may done to facilitate impregnation of the one or more layers of fibrous material with the resin. In some embodiments, the viscosity of the resin may be between 0.55.10⁻³ Pa·s and 50 Pa·s, preferably between 0.05 Pa·s and 2.5 Pa·s, more preferably between 0.1 Pa·s and 0.15 Pa·s (at room temperature). In other embodiments, the viscosity of the resin may be 1 Pa·s or less, preferably 0.5 Pa·s or less, more preferably 0.1 Pa·s or less, even more preferable 0.01 Pa·s or less (at room temperate). Viscosity can be measured using any well-known method in the art.

### General Process

### The Structure

The fibrous material as defined herein and a resin comprising a polymer derived from an aliphatic polyalcohol and an aliphatic polycarboxylic acid as defined herein can be combined to provide a structure as defined below and in the claims.

The fibrous material may be present in the structure in an amount of at least 10 wt. %, calculated on the total weight of the starting materials used, not including water. The fibrous material may be present in the structure in an amount of at most 95 wt. %, calculated on the total weight of the starting materials used, not including water. If the amount of fibrous material is too low, it may be difficult to successfully form the article from the structure, because the structure will be relatively stiff and so may be more difficult to shape. Additionally, the strength of the non-flat article obtained will not be as desired. If the amount of fibrous material is too high, this affects the strength of the article obtainable by the process, because the fibers may then not be properly glued together. This will affect the properties of the non-flat article, such as the (flexural) strength, the look and feel, and appearance. In some embodiments, the amount of fibrous material is from 20 wt. % to 90 wt. %, preferably from 30 wt. % to 85 wt. %, more preferably from 35 wt. % to 80 wt. %, more preferably from 40 wt. % to 80 wt. %, more preferably from 50 wt. % to 80 wt. %.

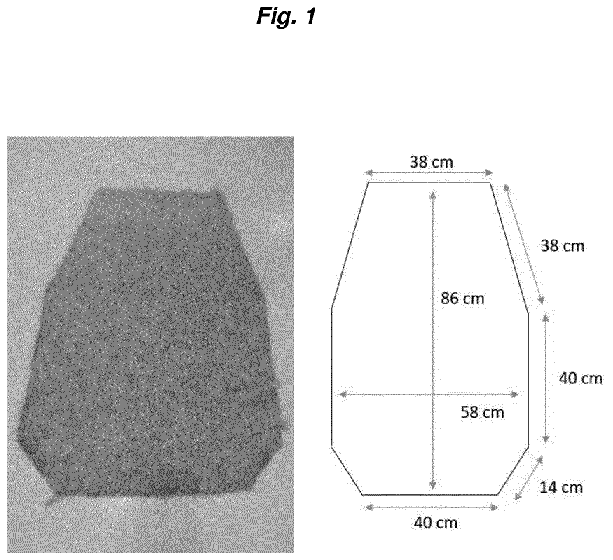

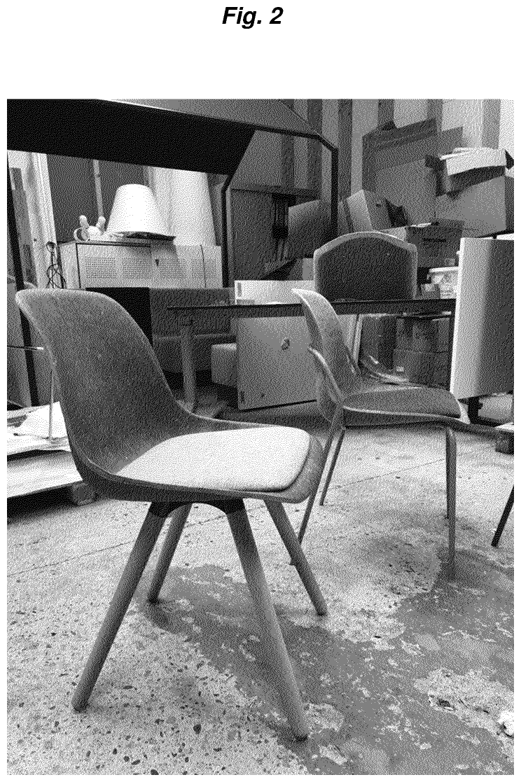

The fibrous material may be cut in a predetermined shape to reduce waste of starting materials and make the forming easier. Cut-offs from the one or more layers of fibrous material can be recycled to make new layers of fibrous material. When manufacturing a seat for a chair, for example, it may be desirable to cut one or more layer of fibrous material substantially in the shape of hemp mat depicted in FIG. 1.

The fibrous material in the structure is at least partly provided with the resin defined herein. Preferably at least 80% of the fibers of the fibrous material are provided with resin, more preferably at least 90%, most preferably at least 95%. The more fibers of the fibrous structure are provided with resin, the easier the manufacturing of non-flat articles from the structure will be. The skilled person would understand that the provision with resin can be done using methods well-known in the art, such as spaying, dipping, roll-coating, vacuum infusion, etc. For example, resin may be (roll-)coated or sprayed onto one or more sides of the fibrous material. In some embodiments, one or more layers of fibrous material are each provided with resin.

The provision of resin may be such that all fiber surface is provided with resin. It is also possible that part of the fiber surface is provided with resin. In the forming step discussed below, the fibers in the structure are pressed together, which will result in a redistribution of the resin. If only part of the fiber surface is covered with resin before the compression step, this redistribution may lead to a larger part of the fiber surface being provided with the resin. It is preferred that in the final article essentially all fiber surface is provided with resin, because the interaction of fibers with resin is at least partially responsible for obtaining the attractive properties of the article at issue. The application of an excess resin may be attractive from a processing point of view to ensure effective coating of the fibers. Excess resin can be removed in any stage of the process using conventional methods such as draining, applying pressure, etc.

The resin, after it has been applied to the fibrous material, may comprise a polymer as defined herein having an extent of polymerisation of between above 0 to 1, preferably between 0.01 and 1, more preferably 0.1 and 0.9, most preferably 0.4 to 0.8. It is also possible for the polymer to have an extent of polymerization of 0, i.e., to contain monomers. It is generally preferred for the resin to contain polymer with an extent of polymerisation as specified above. If the extent of polymerisation immediately prior to forming is too high, it may be difficult to successfully form the structure into an article, especially if the polymers compromise the movement of fibers within the structure. A pre-curing step may be warranted, if the extent of polymerisation is (too) low.

The resin content of the structure may be 5 wt. % to 90 wt. %, preferably 10 wt. % to 70 wt. %, calculated on the total weight of the fibrous material and the weight of the polymer. Preferably, the resin content is 20 wt. % to 55 wt. %. More preferably, the resin content is 30 wt. %

to 50 wt. %. A resin content as defined herein is desirable, as the polymer is thought to bind to the fibers of the fibrous material. This, in turn, results in structural stability after the forming step.

The structure, immediately before it is formed, has a water content between 0.1 wt. % and 60 wt. %, calculated on the total weight of the structure. In some embodiments, the water content of the structure is between 0.1 wt. % and 25 wt. %, preferably between 0.1 wt. % and 20 wt. %, more preferably between 0.1 wt. % and 10 wt. %. A low water content of the structure may be advantageous, because it reduces the time required for forming the structure and, in some cases, reduces waste of the resin through leakage from the structure. A low water content also helps avoid steam explosions occurring during forming, which can damage the fibers and cause safety hazards during forming. The water content is defined as follows: the amount of water in the structure divided by the total mass of the structure.

If the structure has a water content that is too high, it can be subjected to a drying step, to remove excess water. The drying step can be carried out under conditions suitable for removing water. During the drying, little to no polymerisation of the resin will occur. This is because, when a drying step is warranted, the water content is high and because the drying temperature is below a temperature at which significant polymerisation occurs. Drying may be done at a temperature below 60° C., preferably at a temperature of 10° C. to below 60° C., more preferably at a temperature of 10° C. to 50° C., even more preferably at a temperature of 20° C. to 50° C., most preferably at a temperature of 30° C. to 50° C. The drying time is preferably at most 48 hours, more preferably at most 24 hours. In some embodiments, the drying time is much shorter, preferably at most 8 hours, more preferably at most 4 hours, even more preferably at most 2 hours, most preferably at most 1 hour. As a minimum, a drying time of 5 minutes could be mentioned. A reduced pressure may be applied to accelerate drying. The reduced pressure may be 0.9 bars or less, preferably 0.5 bars or less, more preferably 0.1 bars or less. The drying may reduce the water content to below 20 wt. %, preferably to below 10 wt. %, more preferably to below 5 wt. %, most preferably below 2 wt. %, calculated on the total weight of the structure.

Additionally or alternatively, depending on the extent of polymerisation, a (dried) structure can be subjected to a pre-curing step before forming the structure. During the pre-curing, polymerisation of the resin will occur and removal of (reaction) water may occur. Pre-curing may be performed at a temperature of at least 60° C. For example, pre-curing may be performed at a temperature of 60° C. to 140° C., preferably 60° C. to 120° C., more preferably 80° C. to 120° C. If a drying step is applied, the pre-curing may result in an extent of polymerisation of at least 0.6, preferably at least 0.7. If no drying has been applied, the pre-curing may reduce the water content to below 35 wt. %, preferably below 20 wt. %, more preferably below 10 wt. %, even more preferably below 5 wt. %, most preferably below 2 wt. %, calculated on the total weight of the structure. The pre-curing may be done for at least 5 minutes, preferably at least 10 minutes, more preferably at least 1 hour. As a maximum, a pre-curing time of 24 hours may be mentioned. Generally, the pre-curing will be done in an oven. It is advantageous to carefully control the humidity in the oven, because water is removed during drying and so a high humidity would be counterproductive. Accordingly, when pre-curing, the humidity in the oven may be less than 50%, preferably less than 40%. The lower the humidity, the faster the drying process will be.

The structure has a void fraction of at least 0.3, in particular at least 0.4, more in particular at least 0.5, even more in particular at least 0.6, still more in particular at least 0.7. As a general upper limit, a value of at most 0.98 may be mentioned. As mentioned above, the void fraction reflects the volume of voids in a material (which may be filled with a gas, e.g. air) over the total volume of the material and so can be calculated from the densities of the materials. For a material comprising two or more components, a theoretical density of the material can be determined by multiplying the density of each component by the weight fraction of the component and adding the resulting values (cf. Lever rule).

The invention also pertains to a structure suitable for use in the process according to the invention, the structure comprising fibrous material impregnated with resin comprising a polymer derived from an aliphatic polyalcohol with 2-15 carbon atoms and an aliphatic polycarboxylic acid, wherein the structure has a void fraction of 0.3-0.98, the polymer has an extent of polymerisation of 0.5-0.8, and the structure has a water content less than 20 wt. %.

Preferably, the structure has a water content of less than 10 wt. %. Other preferences are discussed above and will be clear from the description.

### Void Fraction Reduction and Forming

The structure, whether or not having been subjected to a drying step and/or a precuring step is then subjected to pressing to reduce void fraction and forming the structure into a non-flat article. The pressing step and the forming step may be combined, but, as is discussed in more detail below, it is also possible to first carry out the pressing step, followed by the forming step.

The pressing step is carried out by applying force onto the structure. The pressure applied may be from 2 to 40 bars (=kg/cm2 structure), preferably from 5 to 30 bars, more preferably from 10 to 20 bars. The duration of the pressing step can be in the range of 15 seconds to 30 minutes, when no simultaneous forming takes place. If simultaneous forming is aimed for, the time may be longer, as is discussed below. The pressing may be done using a thickness control that determines the thickness of the articles obtained by the process. Preferably, the thickness of the articles obtained by the process is in the range from 0.5 mm to 10 cm, preferably 3 mm to 5 cm, more preferably 4 mm to 2 cm. Specifically, if the article is a part for a piece of furniture, the thickness of the article obtained by the process may be in the range of 5 mm to 15 mm, preferably from 7 mm to 12 mm. The temperature applied in the pressing step will depend on whether or not it is intended to only effect void fraction reduction, or whether it is also intended to effect forming. If only void fraction reduction is aimed for, the temperature is e.g., in the range of 10-50° C. If simultaneous forming is aimed for, the temperature will be higher, as is discussed below.

The structure may be pre-shaped, for example by fitting the structure in a mould. It may be advantageous to line the mould, at least partially, with a Teflon coating. This helps prevent sticking of the structure to the mould.

The structure is formed (i.e., shaped) by applying a force. The forming step results in a surprisingly strong article, as well as in increased surface homogeneity and scratch-resistance. The forming step generally takes place in or on a mould, wherein a mould is defined as a shape capable of supporting the structure before the forming step, which ensures that after the forming step an article with the desired shape is obtained.

The force is generally applied by pressing the structure in or on a mould, preferably a mould coated with a Teflon material. The pressure applied may be from 2 to 40 bars (=kg/cm² structure), preferably from 5 to 30 bars, more preferably from 10 to 20 bars. For example, pressure may be applied for a total duration of at least 5 seconds. The longer the duration of the forming, the greater the stability of the article. It will be understood that forming for a very long duration is commercially not attractive. Therefore, a maximum duration of 24 hours may be mentioned, preferably 1 hour, more preferably 10 minutes. The forming may done using a thickness control that determines the thickness of the articles obtained by the process. Preferably, the thickness of the articles obtained by the process is in the range from 0.5 mm to 10 cm, preferably 3 mm to 5 cm, more preferably 4 mm to 2 cm. Specifically, if the article is a part for a piece of furniture, the thickness of the article obtained by the process may be in the range of 5 mm to 15 mm, preferably from 7 mm to 12 mm.

The temperature applied in the forming step is such that the internal temperature of the structure is at or above the glass transition temperature (T_{g}) of the polymer. The T_{g} of the polymer can be measured according to any well-known method in the art and is generally determined using a puncture test. Accordingly, depending on the nature of the polymer, the internal temperature during the forming step may be from 50° C. to 180° C., preferably 60° C. to 180° C., more preferably from 80° C. to 140° C., even more preferably 100° C. to 140° C. An internal temperature of below the T_{g} of the polymer is disadvantageous, because at such an internal temperature the polymer will prevent the fibers from moving relative to each other. In addition, below the T_{g} of the polymer the structure is too brittle to shape and may break. A temperature above 180° C. is also disadvantageous, because this could damage the fibrous material, in particular if the fibrous material comprises cellulosic fibers or lignocellulosic fibers. If it is desired that the polymer also cures quickly during the forming step, the internal temperature during the forming step may be 140° C. to 180° C. , 150° C. to 180° C., preferably 155° C. to 170° C. As discussed above, the forming time may be at least 5 seconds. A maximum of 24 hours may be mentioned. Immediately following the forming, the internal temperature of the non-flat article may be between 100° C. and 130° C.

In some embodiments, water present in the structure subjected to the forming may be removed during forming. In some embodiments, at least 5% of the water present in the structure subjected to the forming is removed, preferably at least 20%, more preferably at least 40%, more preferably at least 60%. As a maximum, 100% of the water present in the structure subjected to the forming may be removed during forming of the article. This also includes water generated during polymerisation of the resin, if polymerisation takes place simultaneously with forming. In the context of the present specification, the wording “simultaneously”, when used in the context of process steps, means that the steps at least partially overlap in time. For example, when polymerisation, void fraction reduction, and forming are carried out simultaneously in a press, it may be that void fraction reduction starts before and/or is completed before polymerisation is completed.

In some embodiments, polymerisation takes place during the forming step. In this embodiment, the extent of polymerisation of the resin in the non-flat article resulting from the forming step is at least 0.1, in particular at least 0.2, higher than the extent of polymerisation of the resin in the structure entering the forming step.

In some embodiments, the extent of polymerisation of the resin in the non-flat article resulting from the forming step is at least 0.7, in particular at least 0.8, more in particular at least 0.9, and the extent of polymerisation of the resin in the structure entering the forming step is in the range of 0-0.7, preferably in the range of 0.3-0.6.

To facilitate the removal of water in the form of steam (i.e., through evaporation), the structure material may, during the forming, be in contact with a water-permeable part. For example, a porous shell may be used when forming the structure. It was found to be advantageous to use a porous shell, wherein, the side of the porous shell that would be in contact with a means for applying force to the structure contains parallel grooves, which each comprise pores. The use of such a porous shell may be advantageous, because it minimizes the distance water (vapour) has to travel to exit the structure and so reduces pressure buildup. The shell may also be used to create particular patterns on the surface of the non-flat article.

The porous shell may have a pore density of 300 to 1000 pores/m², preferably 400 to 900 pores/m², more preferably 500 to 800 pores/m². The pores may have a diameter between 0.5 mm and 3 mm, preferably between 1 mm and 2 mm. A suitable pore size can readily be determined by the skilled person, taking into account the extent of polymerization of the polymer in the composite material. If the extent of polymerization of the polymer is lower (e.g., around 0.40), it may be desirable to use small pores to avoid spillage. If, on the other hand, the extent of polymerization is high(er), the pore size may be larger. The pores are preferably evenly distributed over the shell.

The process of the present invention enables the production of articles with increased visual appeal. This is because, prior to, or during the forming, structure is pressed to reduce the void fraction. As a result, the distance between the fibers is reduced and the resin occupies most or all of the remaining voids. This way, a non-flat article having a homogenous surface can be obtained after the forming. Surface homogeneity of the non-flat article can be determined visually (with the naked eye), e.g., by determining the “gloss” of the surface, by counting cracks and parts of the surface that were not fully impregnated with resin (“white spots”), and/or by touching (feeling) the smoothness of the surface.

After the forming step, the article formed is released from the mould.

After forming, the polymer in the article may have an extent of polymerisation of at least 0.5, preferably at least 0.6, more preferably at least 0.7, in particular at least 0.8. If the extent of polymerisation after forming is too low, one or more curing steps may be warranted to increase the strength of the article, as discussed below. As a maximum, the theoretical extent of polymerisation after forming is 1.0. The water content of the non-flat article immediately after forming is preferably below 10 wt. %, more preferably below 5 wt. %, most preferably below 2 wt. %. When the extent of polymerisation is at least 0.5 and the water content is below 10 wt. %, the non-flat article advantageously has a stable structure, which simplifies downstream processing (e.g. transport of the article and/or further curing steps).

If so desired, the non-flat article resulting from the forming step may be subjected to one or more curing steps (e.g. curing at different temperatures). Preferably, the non-flat article is subjected to two or more curing steps. The curing step is intended to further polymerize the polymer and so increase the strength and water resistance of the article (even) further. The crux of a curing step is, thus, that the polymer is at reaction temperature. The curing step may also be performed to remove or reduce the amount of water left in the non-flat article.

Curing can be carried out using heating technology known in the art, e.g., in an oven. Different types of ovens may be used, including but not limited to belt ovens, convection ovens, infra-red ovens, hot-air ovens, conventional baking ovens and combinations thereof. Curing can be done in a single step, or in multiple steps. Curing times generally range from 5 seconds up to 3 hours, depending on the size and shape of the article and on the type of oven and temperature used. It is within the scope of a person skilled in the art to select suitable curing conditions.

The article may be cured at an internal temperature of 100° C. to 220° C., preferably 100° C. to 180° C., more preferably 120° C. to 170° C. Preferably, the internal temperature during curing is 170° C. or less when the non-flat article comprises natural fibers (e.g., cellulosic or lignocellulosic fibers), because higher temperatures could damage these fibers. When a high water resistance is aimed for, curing preferably takes place at an internal temperature of above 150° C. Accordingly, the curing temperature may then be above 150° C. to 220° C., preferably above 150° C. to 180° C., more preferably above 150° C. to 170° C. The internal temperature is measured during curing or immediately after the article is removed from a means for curing, such as an oven or a press.

The article obtained using the process according to the invention may be cured in two steps. This can be advantageous if the water content in the non-flat article is still relatively high, because a two-step process prevents uneven curing of the non-flat article. In a first curing step, at an internal temperature of from 80° C. to 140° C., preferably from 105° C. to 135° C., more preferably from 110° C. to 130° C. Curing the article at this temperature minimizes the development of blisters on the surface of the article, which would develop if the article was cured at higher temperatures. The first curing step is preferably carried out for at least 15 mins, preferably for at least 25 mins, preferably for at least 30 mins. It may be carried out for as long as desired, but, for commercial reasons, it is generally not carried out for longer than 3 hours.

After the first curing step, the article may be cured, in a second curing step, at an internal temperature of 140° C. to 220° C., preferably 140 to 180° C. Preferably, the internal temperature during curing is 170° C. or less when the non-flat article comprises natural fibers (e.g., cellulosic or lignocellulosic fibers), because higher temperatures could damage these fibers. The second curing step, if still necessary, can be used to increase the strength of the article. It is generally carried out for at least 60 minutes, preferably for at least 90 minutes. For commercial reasons, the second curing step is generally carried out for at most 3 hours. As will be clear to the skilled person, a temperature gradient may also be applied during curing.

After curing, the extent of polymerization will generally be greater than 0.80, preferably greater than 0.90. Moreover, immediately after curing, the water content of the article is generally below 10 wt. % (calculated on the total weight of the article), preferably below 5 wt. %, more preferably below 2 wt. %, most preferably below 1 wt. %. Depending on the storage conditions, the water content of the article may increase after curing.

Depending on the extent of polymerization, the polymers in the article will slowly hydrolyze, when brought in contact with water. Accordingly, if a certain extent of degradability of the article is desired (in packaging applications, for example) a lower extent of polymerization may be selected. In some embodiments, the extent of polymerization of the polymer in the article is between 0.6 and 1.0, preferably between 0.8 and 1.0, more preferably between 0.95 and 1.00. However, if a more stable material is desired, a higher extent of polymerization would be preferred. Therefore, in some embodiments, the extent of polymerization of polymer in the non-flat article is at least 0.90, preferably at least 0.95, most preferably at least 0.98. Generally, non-flat articles having a lower extent of polymerization are more flexible than non-flat articles having a higher extent of polymerization.

Because, depending on the extent of polymerization, the polymer in the non-flat articles can be hydrolysed, the polymer in the non-flat articles will in some embodiments slowly degrade, leaving the fibrous material and the polymer available for biological degradation. Accordingly, in some embodiments, the non-flat article is biologically degradable. Moreover, as the polymer consists essentially of carbon, hydrogen, and oxygen atoms, it shows a clean burning profile, as well as a good suitability for disposal as organic waste.

As will be evident to the skilled person, the extent of polymerisation of the article obtained after curing is at least as high as, and generally higher than the extent of polymerisation of the article obtained after forming. The extent of polymerisation of the article obtained after forming is at least as high as, and generally higher than the extent of polymerisation of the article subjected to the forming step. The extent of polymerisation of the structure obtained after pre-curing is higher than the extent of polymerisation of the structure before pre-curing. The extent of polymerisation of the resin as it is provided to the structure is at most as high as, and generally lower than the extent of polymerisation of the resin after curing (following forming).

Accordingly, as indicated above, a general process for manufacturing a non-flat article comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, or the precursor monomers of such polymer, wherein the structure has a void fraction of 0.3-0.98 and a water content of below 40 wt. %, and
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 20 wt. %,
wherein polymerisation (if carried out), reduction of void fraction, and forming are carried out simultaneously,
wherein polymerisation (if carried out) and reduction of void fraction are carried out simultaneously, followed by forming,
wherein polymerisation (if carried out) and reduction of void fraction are carried out sequentially in any order, followed by forming, or
wherein polymerisation (if carried out) is followed by reduction of void fraction and forming, with forming being carried out simultaneously with void fraction reduction or subsequent thereto.

It is preferred to cure the non-flat article obtained after forming. Therefore, a preferred general process for manufacturing a non-flat article comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, or the precursor monomers of such polymer, wherein the structure has a void fraction of 0.3-0.98 and a water content of below 40 wt. %,
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 20 wt. %,
wherein polymerisation (if carried out), reduction of void fraction, and forming are carried out simultaneously,
wherein polymerisation (if carried out) and reduction of void fraction are carried out simultaneously, followed by forming,
wherein polymerisation (if carried out) and reduction of void fraction are carried out sequentially in any order, followed by forming, or
wherein polymerisation (if carried out) is followed by reduction of void fraction and forming, with forming being carried out simultaneously with void fraction reduction or subsequent thereto,
and curing the non-flat article at an internal temperature of at least 80° C.

It is also preferred that polymerisation, reduction of void fraction, and forming are carried out (substantially) simultaneously. Accordingly, a more preferred general process for manufacturing a non-flat article comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, or the precursor monomers of such polymer, wherein the structure has a void fraction of 0.5-0.98 and a water content of below 40 wt. %,
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 20 wt. %,
wherein polymerisation (if carried out), reduction of void fraction, and forming are carried out simultaneously,
and curing the non-flat article at an internal temperature of at least 80° C.

### First Embodiment

In a first embodiment of the invention, the structure is simultaneously subjected to polymerising, pressing, and forming steps. This embodiment is discussed below. The first embodiment can be combined with any of the features of the fibrous material, the resin and the general process described above.

Accordingly, in the first embodiment, a process for manufacturing a non-flat article is disclosed, which comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of below 40 wt. %, and
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 20 wt. %,
wherein polymerisation (if carried out), reduction of void fraction, and forming are carried out simultaneously.

It is preferred to cure the non-flat article obtained after forming. Therefore, a preferred process for manufacturing a non-flat article of the first embodiment comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of below 40 wt. %,
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 20 wt. %,
wherein polymerisation (if carried out), reduction of void fraction, and forming are carried out simultaneously, and
curing the non-flat article at an internal temperature of at least 80° C.

It is preferred that the structure is pre-cured. Accordingly, more preferred process for manufacturing a non-flat article of the first embodiment comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of below 40 wt. %,
pre-curing the structure at an internal temperature of 60° C. to 140° C.,
subjecting the structure to the following steps,
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 20 wt. %,
wherein polymerisation (if carried out), reduction of void fraction, and forming are carried out simultaneously, and
curing the non-flat article at an internal temperature of at least 80° C.

In the first embodiment, the fibrous material in the structure is at least partly provided with the resin defined herein. Preferably at least 80% of the fibers of the fibrous material are provided with resin, more preferably at least 90%, most preferably at least 95%. The more fibers of the fibrous structure are provided with resin, the easier and more consistent the manufacturing of non-flat articles from the structure will be. The skilled person would understand that the provision with resin can be done using methods well-known in the art, such as spaying, dipping, roll-coating, etc. For example, resin may be sprayed onto one or more sides of the fibrous material. In some embodiments, one or more layers of fibrous material are each provided with resin.

In the first embodiment, the provision of resin may be such that all fiber surface is provided with resin. It is also possible that part of the fiber surface is provided with resin. In the forming step discussed below, the fibers in the structure are pressed together, which will result in a redistribution of the resin. If only part of the fiber surface is covered with resin before the compression step, this redistribution may lead to a larger part of the fiber surface being provided with the resin. It is preferred that in the final article essentially all fiber surface is provided with resin, because the interaction of fibers with resin is at least partially responsible for obtaining the attractive properties of the article at issue.

In the first embodiment, the structure, immediately before it is formed, has a water content between 1 wt. % and 40 wt. %, calculated on the total weight of the structure. In some embodiments, the water content of the structure is between 1 wt. % and 35 wt. %, preferably between 2 wt. % and 30 wt. %, more preferably between 3 wt. % and 25 wt. %, most preferably between 4 wt. % and 20 wt. %. A low water content of the structure is advantageous, because it reduces the time required for forming the structure and because it reduces waste of the resin through leakage from the structure.

In the first embodiment, the extent of polymerisation of the polymer in the structure entering the forming step may be above 0 to 0.7, preferably 0.1 to 0.6, more preferably 0.1 to 0.5, even more preferably 0.2 to 0.5, even more preferably 0.3 to 0.5.

In the first embodiment, the viscosity of the resin may be between 0.55.10⁻³ Pa·s and 50 Pa·s, preferably between 0.05 Pa·s and 2.5 Pa·s, more preferably between 0.1 Pa·s and 0.15 Pa·s (at room temperature).

In the first embodiment, the structure may be pre-shaped prior to forming, for example by fitting the structure in a mould. It may be advantageous to line the mould, at least partially, with a Teflon coating. This helps prevent sticking of the structure to the mould.

In the first embodiment, the structure is formed (i.e., shaped) by applying a force on the structure, the structure having an internal temperature sufficient to evaporate water. The forming step results in a surprisingly strong article, as well as in increased surface homogeneity and scratch-resistance. The forming step generally takes place in a mould, wherein a mould is defined as a hollow shape capable of containing the structure before the forming step, which ensures that after the forming step an article with the desired shape is obtained.

In the first embodiment, the force is generally applied by pressing the structure in a mould, preferably a mould coated with a Teflon material. The pressure applied may be from 2 to 40 bars, preferably from 5 to 30 bars, more preferably from 10 to 20 bars. The pressure may be applied for a total duration of at least 5 seconds. The longer the duration of the forming, the greater the stability of the article. It will be understood that forming for a very long duration is commercially not attractive. Therefore, a maximum duration of 24 hours may be mentioned, preferably 1 hour, more preferably 10 minutes. Preferably, the forming time is less than 10 minutes. The forming may done using a thickness control that determines the thickness of the articles obtained by the process. Preferably, the thickness of the articles obtained by the process is in the range from 0.5 mm to 10 cm, preferably 3 mm to 5 cm, more preferably 4 mm to 2 cm. Specifically, if the article is a part for a piece of furniture, the thickness of the article obtained by the process may be the range of 5 mm to 15 mm, preferably from 7 mm to 12 mm.

In the first embodiment, the temperature applied in the forming step is such that the internal temperature of the structure is above the T_{g} of the polymer and water is removed. Accordingly, depending on the nature of the polymer and the pressure, the temperature during the forming step may be from 50° C. to 180° C., preferably from 80° C. to 140° C., more preferably 100° C. to 140° C. An internal temperature of below the T_{g} of the polymer is disadvantageous, because at such an internal temperature the polymer will prevent the fibers from moving relative to each other. Moreover, at a temperature below the T_{g} of the polymer, the structure is brittle and may break. An internal temperature above 180° C. is also disadvantageous, because this could damage the fibrous material. As discussed above, the forming time may be at least 5 seconds. A maximum of 24 hours may be mentioned. Preferably, the forming time is less than 10 minutes. Immediately following the forming, the internal temperature of the non-flat article may be between 80° C. and 140° C.

In the first embodiment, the water present in the structure subjected to the forming may be removed during forming. In the first embodiment, at least 5% of the water present in the structure subjected to the forming may be removed, preferably at least 20%, more preferably at least 40%, more preferably at least 60%. As a maximum, 100% of the water present in the structure subjected to the forming may be removed during forming of the article.

In the first embodiment, to facilitate the removal of water in the form of steam (i.e., through evaporation), the structure material may, during the forming, be in contact with a waterpermeable part. For example, a porous shell may be used when forming the structure. It was found to be advantageous to use a porous shell, wherein, the side of the porous shell that would be in contact with a means for applying force to the structure contains parallel grooves, which each comprise pores. The use of such a porous shell is advantageous, because minimizes the distance water (vapour) has to travel and so reduces pressure buildup. The shell may also be used to create a particular patterns on the surface of the non-flat article.

In the first embodiment, the porous shell may have a pore density of 300 to 1000 pores/m², preferably 400 to 900 pores/m², more preferably 500-800 pores/m². The pores may have a diameter between 0.5 mm and 3 mm, preferably between 1 mm and 2 mm. A suitable pore size can readily be determined by the skilled person, taking into account the extent of polymerization of the polymer in the composite material. If the extent of polymerization of the polymer is lower (e.g., around 0.40), it may be desirable to use small pores to avoid spillage. If, on the other hand, the extent of polymerization is high(er), the pore size may be greater. The pores are preferably evenly distributed over the shell.

In the first embodiment, after the forming step, the article formed is released from the mould.

In the first embodiment, after forming, the polymer in the article may have an extent of polymerisation of at least 0.5, preferably at least 0.6, more preferably at least 0.7. If the extent of polymerisation after forming is too low, the further curing steps may be warranted to increase the strength of the article. As a maximum, the theoretical extent of polymerisation after forming is 1.0. The water content immediately after forming is preferably below wt. %, more preferably below 10 wt. %, most preferably below 5 wt. %. When the extent of polymerisation is at least 0.5 and the water content is below 20 wt. %, the non-flat article advantageously has a stable structure, which simplifies downstream processing (e.g. transport of the article and/or further curing steps).

### Second Embodiment

In a second embodiment of the invention, the structure is sequentially subjected to a drying step, followed by simultaneous polymerising, pressing and forming steps. This embodiment is discussed below. The second embodiment can be combined with any of the features of the fibrous material, the resin and the general process.

Accordingly, in the second embodiment, a process for manufacturing a non-flat article is disclosed, which comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of 20 wt. % to 60 wt. %.
drying the structure at a temperature of 10° C. to below 60° C.,
obtaining a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of below 20 wt. %, and
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 20 wt. %,
wherein polymerisation (if carried out), reduction of void fraction, and forming are carried out (substantially) simultaneously.

It is preferred that the non-flat article is cured. Therefore, a preferred process for manufacturing a non-flat article of the second embodiment comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of 20 wt. % to 60 wt. %,
drying the structure at a temperature of 10° C. to below 60° C.,
obtaining a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of below 10 wt. %,
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5 and a water content less than 10 wt. %,
wherein polymerisation (if carried out), reduction of void fraction, and forming are carried out (substantially) simultaneously, and
curing the non-flat article at an internal temperature of at least 80° C.

In the second embodiment, the fibrous material in the structure is at least partly provided with the resin defined herein. Preferably at least 80% of the fibers of the fibrous material are provided with resin, more preferably at least 90%, most preferably at least 95%. The more fibers of the fibrous structure are provided with resin, the easier the manufacturing of non-flat articles from the structure will be. The skilled person would understand that the provision with resin can be done using methods well-known in the art, such as spaying, dipping, roll-coating, etc. For example, the resin may be (roll-)coated on one or more sides of the fibrous material. In some embodiments, one or more layers of fibrous material are each provided with resin. Preferably, the resin is diluted with water, as this facilitates the impregnation of the fibrous material.

In the second embodiment, it is preferred that in the final article essentially all fiber surface is provided with resin, because the interaction of fibers with resin is at least partially responsible for obtaining the attractive properties of the article at issue.

In the second embodiment, the structure, immediately after impregnation with (diluted) resin, has a water content between 10 wt. % and 60 wt. %, calculated on the total weight of the structure. In some embodiments, the water content of the structure is between 15 wt. % and 55 wt. %, preferably between 20 wt. % and 50 wt. %, more preferably between 20 wt. % and 45 wt. %.

In the second embodiment, the viscosity of the resin may be 1 Pa·s or less, preferably 0.5 Pa·s or less, more preferably 0.1 Pa·s or less, even more preferable 0.01 Pa·s or less (at room temperate). A minimum viscosity of 1.10⁻⁵ Pa·s may be mentioned.

In the second embodiment, the structure is then subjected to a drying step, to remove excess water. The drying step can be carried out under conditions suitable for removing water. During the drying, no polymerisation of the resin will occur. Drying may be done at a temperature below 60° C., preferably at a temperature of 10° C. to below 60° C., more preferably at a temperature of 10° C. to 50° C., even more preferably at a temperature of 20° C. to 50° C., more preferably at a temperature of 30° C. to 50° C. The drying time is preferably at most 3 hours, more preferably at most 2 hours, most preferably at most 1 hour. As a minimum, a drying time of 5 minutes could be mentioned. The drying may reduce the water content to below 20 wt. %, preferably to below 10 wt. %, more preferably to below 5 wt. %, most preferably below 2 wt. %, calculated on the total weight of the structure.

In the second embodiment, the structure, after drying and before forming, has a water content between 0.1 wt. % and 20 wt. %, calculated on the total weight of the structure. In some embodiments, the water content of the structure is between 0.1 wt. % and 20 wt. %, preferably between 1 wt. % and 10 wt. %, more preferably between 1 wt. % and 5 wt. %. A low water content of the structure is advantageous, because it reduces the time required for forming the structure, it reduces waste of the resin through leakage from the structure, and it helps avoid any difficulties that may be encountered during forming when the water content is (too) high.

In the second embodiment, the (dried) structure may be subjected to a (pre-)curing step prior to forming. The (pre-)curing may be done at an internal temperature of from 60° C. to 140° C., preferably from 80° C. to 120° C. The (pre-)curing may be done for at least 5 minutes, preferably at least 10 minutes, more preferably at least 1 hour. Generally, the precuring will be done in an oven. It is advantageous to carefully control the humidity in the oven, because water is removed during drying and so a high humidity would be counterproductive. Accordingly, when (pre-)curing, the humidity in the oven may be less than 50%, preferably less than 40%. The (pre-)curing may result in an extent of polymerisation of at least 0.6, preferably at least 0.7, more preferably at least 0.8.

In the second embodiment, the force applied during forming may be applied by pressing the structure in a mould, preferably a mould coated with a polytetrafluoroethylene material or another material that simplifies removal of the non-flat article from a means for forming the non-flat article after forming. The pressure applied may be from 2 to 40 bars, preferably from 5 to 30 bars, more preferably from 10 to 20 bars. The pressure may be applied for a total duration of at least 5 seconds. The longer the duration of the forming, the greater the stability of the article. It will be understood that forming for a very long duration is commercially not attractive. Therefore, a maximum duration of 24 hours may be mentioned, preferably 1 hour, more preferably 10 minutes, most preferably 5 minutes. Preferably, the forming time is less than 10 minutes. The forming may done using a thickness control that determines the thickness of the articles obtained by the process. Preferably, the thickness of the articles obtained by the process is in the range from 0.5 mm to 10 cm, preferably 3 mm to 5 cm, more preferably 4 mm to 2 cm. Specifically, if the article is a part for a piece of furniture, the thickness of the article obtained by the process may be the range of 5 mm to 15 mm, preferably from 7 mm to 12 mm.

In the second embodiment, the temperature applied in the forming step is above the T_{g} of the polymer. Accordingly, depending on the nature of the polymer, the temperature during the forming step may be from 60° C. to 180° C., preferably from 80° C. to 140° C., more preferably 100° C. to 140° C. As discussed above, an internal temperature of below the T_{g} of the polymer is disadvantageous, because at such an internal temperature the polymer will prevent the fibers from moving relative to each other. An internal temperature above 180° C. is also disadvantageous, because this could damage the fibrous material.

In the second embodiment, it is not necessary to remove water during forming, as almost all water has evaporated during the drying step. The drying step in this embodiment is advantageous, because drying is very efficient as a result of the high void fraction and surface area of the fibrous material used. Low temperatures and short drying times can give satisfactory results. Nevertheless, some water may still be removed during forming. For example, at least 5% of the water (still) present in the structure subjected to the forming may be removed, preferably at least 10%, more preferably at least 20%, more preferably at least 30%. As a maximum, 100% of the water (still) present in the structure subjected to the forming may be removed during forming of the article.

In the second embodiment, after forming, the polymer in the article may have an extent of polymerisation of at least 0.5, preferably at least 0.6, more preferably at least 0.7, most preferably at least 0.8. If the extent of polymerisation after forming is too low, the further curing steps may be warranted to increase the strength of the article. As a maximum, the theoretical extent of polymerisation after forming is 1.0. The water content immediately after forming is preferably below 10 wt. %, more preferably below 5 wt. %, most preferably below 2 wt. %. When the extent of polymerisation is at least 0.5 and the water content is below 10 wt. %, the non-flat article advantageously has a stable structure, which simplifies downstream processing (e.g. transport of the article and/or further curing steps).

### Third Embodiment

In a third embodiment of the invention, the structure as defined in claim 1 is sequentially subjected to, in order drying and polymerising steps, followed by simultaneous pressing and forming steps. This embodiment is discussed below. The third embodiment can be combined with any of the features of the fibrous material and the resin, as well as the features of the general process.

Accordingly, in the third embodiment, a process for manufacturing a non-flat article is disclosed, which comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of 20 to 60 wt. %,
drying the structure at a temperature of 10 to below 60° C.,
pre-curing the structure at an internal temperature of 60° C. to 140° C.,
obtaining a structure comprising a fibrous material and a resin comprising a polymer derived from an aliphatic polyalcohol with 2-15 carbon atoms and an aliphatic polycarboxylic acid that has an extent of polymerization of above 0 to 1.0, or the precursor monomers of such polymer, wherein the structure has a void fraction of 0.3-0.98 and a water content of below 20 wt. %, and
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5, preferably at least 0.6, and a water content less than 20 wt. %,
wherein polymerisation (if carried out), reduction of void fraction, and forming are carried out (substantially) simultaneously.

It is preferred that the non-flat article is cured. Accordingly preferred process for manufacturing a non-flat article of the third embodiment comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.3-0.98 and a water content of 20 wt. % to 60 wt. %,
drying the structure at a temperature of 10° C. to below 60° C.,
pre-curing the structure at an internal temperature of 60° C. to 140° C.,
obtaining a structure comprising a fibrous material and a resin comprising a polymer derived from an aliphatic polyalcohol with 2-15 carbon atoms and an aliphatic polycarboxylic acid that has an extent of polymerization of above 0 to 1.0, or the precursor monomers of such polymer, wherein the structure has a void fraction of 0.3-0.98 and a water content of below 10 wt. %,
subjecting the structure to the following steps
   if the extent of polymerisation is below 0.5, polymerising to an extent of polymerisation of 0.5-1,
   pressing to reduce void fraction, and
   forming the structure into a non-flat article by applying a force at an internal temperature above T_{g} of the polymer, the resulting non-flat article having an extent of polymerisation of at least 0.5, preferably at least 0.6, and a water content less than 10 wt. %,
wherein polymerisation (if carried out), reduction of void fraction, and forming are carried out (substantially) simultaneously, and
curing the non-flat article at an internal temperature of at least 80° C.

Preferably, the pre-curing results in a structure having an extent of polymerisation of 0.5-1. Therefore, a more preferred process for manufacturing a non-flat article of the third embodiment comprises the steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, preferably above 0 to 0.6, or the precursor monomers of such polymer, wherein the structure has a void fraction of 0.5-0.98 and a water content of 20 wt. % to 60 wt. %
drying the structure at a temperature of 10° C. to below 60° C.,
pre-curing the structure at an internal temperature of 60° C. to 140° C.,
obtaining a structure comprising a fibrous material and a resin comprising a polymer derived from an aliphatic polyalcohol with 2-15 carbon atoms and an aliphatic polycarboxylic acid that has an extent of polymerization of 0.5 to 1.0, or the precursor monomers of such polymer, wherein the structure has a void fraction of 0.5-0.98 and a water content of below 5 wt. %,
subjecting the structure to the following steps
   pressing to reduce void fraction, and
   forming the structure into a non-flat article by applying a force at an internal temperature above T_{g} of the polymer, the resulting non-flat article having an extent of polymerisation of at least 0.5, preferably at least 0.6, and a water content less than 5 wt. %,
wherein reduction of void fraction and forming are carried out (substantially) simultaneously, and
curing the non-flat article at an internal temperature of at least 80° C.

In the third embodiment, the fibrous material in the structure is at least partly provided with the resin defined herein. Preferably at least 80% of the fibers of the fibrous material are provided with resin, more preferably at least 90%, most preferably at least 95%. The more fibers of the fibrous structure are provided with resin, the easier the manufacturing of nonflat articles from the structure will be. The skilled person would understand that the provision with resin can be done using methods well-known in the art, such as spaying, dipping, roll-coating, etc. For example, the resin may be (roll-)coated on one or more sides of the fibrous material. In some embodiments, one or more layers of fibrous material are each provided with resin. Preferably, the resin is diluted with water, as this facilitates the impregnation of the fibrous material.

In the third embodiment, it is preferred that in the final article essentially all fiber surface is provided with resin, because the interaction of fibers with resin is at least partially responsible for obtaining the attractive properties of the article at issue.

In the third embodiment, the structure, immediately after impregnation with (diluted) resin, has a water content between 10 wt. % and 60 wt. %, calculated on the total weight of the structure. In some embodiments, the water content of the structure is between 15 wt. % and 55 wt. %, preferably between 20 wt. % and 50 wt. %, more preferably between 20 wt. % and 45 wt. %.

In the third embodiment, the viscosity of the resin may be 1 Pa·s or less, preferably 0.5 Pa·s or less, more preferably 0.1 Pa·s or less, even more preferable 0.01 Pa·s or less (at room temperate). A minimum viscosity of 1.10-5 Pa·s may be mentioned.

In the third embodiment, the structure is then subjected to a drying step, to remove excess water. The drying step can be carried out under conditions suitable for removing water. During the drying, no polymerisation of the resin will occur. Drying may be done at a temperature below 60° C., preferably at a temperature of 10° C. to below 60° C., preferably at a temperature of 10° C. to 50° C. The drying time is preferably at most 3 hours, more preferably at most 2 hours, most preferably at most 1 hour. As a minimum, a drying time of 5 minutes could be mentioned. The drying may reduce the water content to below 20 wt. %, preferably to below 10 wt. %, more preferably to below 5 wt. %, most preferably below 2 wt. %, calculated on the total weight of the structure.

In the third embodiment, the structure, after drying and before forming, has a water content between 0.1 wt. % and 20 wt. %, calculated on the total weight of the structure. In some embodiments, the water content of the structure is between 0.1 wt. % and 20 wt. %, preferably between 1 wt. % and 15 wt. %, more preferably between 1 wt. % and 10 wt. %. A low water content of the structure is advantageous, because it reduces the time required for forming the structure, it reduces waste of the resin through leakage from the structure, and it helps avoid any difficulties that may be encountered during forming when the water content is (too) high.

In the third embodiment, the (dried) structure is subjected to a (pre-)curing step prior to forming. The (pre-)curing may be done at an internal temperature of from 60° C. to 140° C., preferably 60° C. to 120° C., more preferably from 80° C. to 120° C. The (pre-)curing may be done for at least 5 minutes, preferably at least 10 minutes, more preferably at least 1 hour. Generally, the (pre-)curing will be done in an oven. It is advantageous to carefully control the humidity in the oven, because water is removed during drying and so a high humidity would be counterproductive. Accordingly, when (pre-)curing, the humidity in the oven may be less than 50%, preferably less than 40%. The (pre-)curing may result in an extent of polymerisation of at least 0.6, preferably at least 0.7, more preferably at least 0.8.

In the third embodiment, the force is applied during forming is applied by pressing the structure in a mould, preferably a mould coated with a polytetrafluoroethylene material or another material that simplifies removal of the non-flat article from a means for forming the non-flat article after forming. The pressure applied may be from 2 to 40 bars, preferably from 5 to 30 bars, more preferably from 10 to 20 bars. The pressure may be applied for a total duration of at least 5 seconds. The longer the duration of the forming, the greater the stability of the article. It will be understood that forming for a very long duration is commercially not attractive. Therefore, a maximum duration of 24 hours may be mentioned, preferably 1 hour, more preferably 10 minutes, most preferably 5 minutes. Preferably, the forming time is less than 10 minutes, more preferably less than 5 minutes. The forming may done using a thickness control that determines the thickness of the articles obtained by the process. Preferably, the thickness of the articles obtained by the process is in the range from 0.5 mm to 10 cm, preferably 3 mm to 5 cm, more preferably 4 mm to 2 cm. Specifically, if the article is a part for a piece of furniture, the thickness of the article obtained by the process may be the range of 5 mm to 15 mm, preferably from 7 mm to 12 mm.

In the third embodiment, the temperature applied in the forming step is above the T_{g} of the polymer. Accordingly, depending on the nature of the polymer, the temperature during the forming step may be from 60° C. to 180° C., preferably from 80° C. to 140° C., more preferably 100° C. to 140° C. As discussed above, an internal temperature of below the T_{g} of the polymer is disadvantageous, because at such an internal temperature the polymer will prevent the fibers from moving relative to each other. An internal temperature above 180° C. is also disadvantageous, because this could damage the fibrous material.

In the third embodiment, it is not necessary to remove water during forming, as almost all water has evaporated during the drying and pre-curing steps. The drying step in this embodiment is advantageous, because drying is very efficient as a result of the high void fraction and surface area of the fibrous material used. Low temperatures and short drying times can give satisfactory results. Nevertheless, some water may still be removed during forming. For example, at least 5% of the water (still) present in the structure subjected to the forming is removed, preferably at least 10%, more preferably at least 20%, more preferably at least 30%. If a shell for facilitating the evaporation of water is present during forming, at least 20% of the water (still) present in the structure subjected to the forming may be removed, preferably at least 40%, more preferably at least 60%. As a maximum, 100% of the water (still) present in the structure subjected to the forming may be removed during forming of the article.

In the third embodiment, after forming, the polymer in the article may have an extent of polymerisation of at least 0.5, preferably at least 0.6, more preferably at least 0.7, most preferably at least 0.8. If the extent of polymerisation after forming is too low, the further curing steps may be warranted to increase the strength of the article. As a maximum, the theoretical extent of polymerisation after forming is 1.0. The water content immediately after forming is preferably below 10 wt. %, more preferably below 5 wt. %, most preferably below 2 wt. %. When the extent of polymerisation is at least 0.5 and the water content is below 10 wt. %, the non-flat article advantageously has a stable structure, which simplifies downstream processing (e.g. transport of the article and/or further curing steps).

### Fourth Embodiment

In a fourth embodiment of the invention, the structure as defined in claim 1 is sequentially subjected to polymerising and pressing steps, wherein the pressing results in a flat article. flat article is then subjected to forming at an internal temperature above the T_{g} of the polymer. This embodiment is discussed below and can be combined with the features of the general process, the second and third embodiments.

Accordingly, in the fourth embodiment, the structure provided or obtained is pressed to form a flat article. In one variation of the fourth embodiment, the steps of polymerising and pressing to reduce void fraction are carried out simultaneously, followed by a forming step. In another variation of the fourth embodiment, the steps of polymerising and pressing to reduce void fraction are carried out sequentially in any order, followed by a forming step. In yet another variation of the fourth embodiment, the step of polymerising is followed by pressing to reduce void fraction and forming, with forming being carried out simultaneously with pressing to reduce void fraction reduction or subsequent thereto.

The flat article may be cooled to room temperature. The resulting flat articles are generally very rigid, especially when cured at a temperature above 100° C. for several hours. The pressure applied to form a flat article may be from 2 to 40 bars (i.e., kg/cm² of structure), preferably from 5 to 30 bars, more preferably from 10 to 20 bars. For example, pressure may be applied for a total duration of at least 5 seconds and at most 24 hours. Surprisingly, these flat articles can be reshaped by heating the article to an internal temperature above the T_{g} of the polymer and (pressing and) forming the flat article into a non-flat article. Depending on the specific embodiment, this may allow the production of complex, non-flat articles, without a means for forming that can withstand high temperatures and high pressures for prolonged periods of time. Heated moulds that can withstand high pressures are expensive and so methods not requiring such moulds are advantageous.

In the fourth embodiment, the force applied during forming may be applied by pressing the structure in a mould, preferably a mould coated with a Teflon material. The pressure applied may be from 1 atm to 40 bars, preferably from 5 to 30 bars, more preferably from 10 to 20 bars. The pressure may be applied for a total duration of at least 5 seconds. The longer the duration of the forming, the greater the stability of the article. It will be understood that forming for a very long duration is commercially not attractive. Therefore, a maximum duration of 24 hours may be mentioned, preferably 1 hour, more preferably 10 minutes. Preferably, the forming time is less than 10 minutes. The forming may be done using a thickness control that determines the thickness of the articles obtained by the process. Preferably, the thickness of the articles obtained by the process is in the range from 0.5 mm to 10 cm, preferably 3 mm to 5 cm, more preferably 4 mm to 2 cm. Specifically, if the article is a part for a piece of furniture, the thickness of the article obtained by the process may be the range of 5 mm to 15 mm, preferably from 7 mm to 12 mm.

In the fourth embodiment, the temperature applied in the forming step is above the T_{g} of the polymer. Accordingly, depending on the nature of the polymer, the temperature during the forming step may be from 60° C. to 180° C., preferably from 80° C. to 140° C., more preferably 100° C. to 140° C. An internal temperature of below the T_{g} of the polymer is disadvantageous, because at such an internal temperature the polymer will prevent the fibers from moving relative to each other. An internal temperature above 180° C. is also disadvantageous, because this could damage the fibrous material. Moreover, when the internal temperature is below the T_{g} of the polymer, the structure is brittle and may break. As discussed above, the forming time may be at least 5 seconds. A maximum of 24 hours may be mentioned. Preferably, the forming time is less than 10 minutes. Immediately following the forming, the internal temperature of the non-flat article may be between 80 and 140° C.

### Non-Flat Article

The present invention also pertains to an article obtainable by the process according to the invention. The non-flat article has a flexural strength greater than 20 MPa, for example as determined using ASTM D 7264.

Accordingly, the invention pertains to a non-flat article comprising fibrous material impregnated with resin comprising a polymer derived from an aliphatic polyalcohol with 2 to 15 carbon atoms and an aliphatic polycarboxylic acid (preferably with 3 to 15 carbon atoms), the polymer having an extent of polymerisation of at least 0.5 and the non-flat article having a water content of less than 20 wt. %, and a flexural strength of greater than 20 MPa, for example as determined using ASTM D 7264. The non-flat article may have a void fraction of 0.8 or less, preferably 0.7 or less, more preferably 0.5 or less, even more preferably 0.4 or less, yet more preferably 0.35 or less, still more preferably 0.3 or less, most preferably 0.2 or less.

For the nature of the polymer and the filler in the non-flat article according to the invention, reference is made to what is stated above in the context of the process according to the invention. Any preferences specified for polymer and the (layers of) fibrous material used in the process according to the invention also apply to the polymer and the (layers of fibrous material) in the article according to the invention.

In some embodiments, the non-flat article has a flexural strength (as measured using a three-point flexural test, e.g., as defined in ASTM D7264) of at least 20 MPa, preferably at least 25 MPa, more preferably at least 30 MPa, in particular at least 40 MPa, most preferably at least 50 MPa. In general, the flexural strength should be as high as possible. An upper limit to the flexural strength of the non-flat article may, for example, be 200 MPa.

The density of the non-flat article may be at least 0.3 g/cm³, in particular at least 0.7 g/cm³, preferably at least 0.8 g/cm³, more preferably at least 0.9 g/cm³, preferably at least 1.0 g/cm³, preferably at least 1.1 g/cmcm³. It may be desirable for the non-flat article to have a density of at most 1.4 g/cm³, when the non-flat article comprises natural fibers (e.g., cellulosic fibers, such as hemp). Non-flat articles comprising fibrous materials with fibers having a higher intrinsic density may have a higher density than 1.4 g/cm³.

In embodiments where non-flat articles of high durability and high strength are aimed for, the article of the present invention has an extent of polymerisation of at least 0.8, preferably at least 0.9, more preferably at least 0.95.

The water content of the non-flat article is less than 20 wt. %, calculated on the total weight of the non-flat article. The water content is preferably 15 wt. % or less, more preferably 10 wt. % or less. In some embodiments, the water content of the non-flat article is as defined above after 24 hours of storage at 50% (relative) humidity and a temperature of 20° C., more preferably after 48 hours, most preferably after 72 hours. As indicated above, water resistance increases with, for example, increased curing temperature.

In a specific embodiment, the invention pertains to a non-flat article obtainable by the process according to the invention comprising 30 to 80 wt. % of hemp fibers, preferably randomly oriented hemp fibers, and 20 to 70 wt. % of resin, preferably resin derived from glycerol and citric acid, the polymer in the non-flat article having an extent of polymerisation of at least 0.8, in particular at least 0.9, more in particular at least 0.95, the non-flat article having a water content of at most 20 wt. %, in particular at most 15 wt. %, more in particular at most 10 wt. %, a void fraction of at most 0.6, preferably at most 0.5, more preferably at most 0.4, even more preferably at most 0.35, a density of between 0.6 and 1.4 g/cm³ preferably between 0.8 and 1.4 g/cm³, and a flexural strength (as measured using a three-point flexural test, e.g., as defined in ASTM D7264) of at least 30 MPa, most preferably at least 40 MPa.

It has been found that (non-woven) hemp fibers can advantageously be used in the process according to the invention, as hemp fibers provide a very desirable shapeability to the structure. In some embodiments, therefore, the non-flat article is a fiber board, wherein the fibrous material comprises hemp fibers. The fiber board may comprise at least 10 wt. % of a polymer as defined herein, preferably at least 20 wt. %, most preferably at least 30 wt. %. In some embodiments, the fiber board comprises at most 80 wt. % of a polymer as defined herein, preferably at most 70 wt. %, more preferably at most 60 wt. %, most preferably at most 50 wt. %. If the amount of polymer in a fiber board is too high or too low, its mechanical properties (e.g., its flexural strength) will decrease.

It will be evident to the skilled person that preferences expressed for the process of the present invention can be combined, unless these are mutually exclusive. Similarly, preferences expressed for the process according to the invention also apply to the non-flat article obtained by the process according to the invention, the non-flat article according to the invention, and the structure for use in the process according to the invention.

The present invention will be elucidated by the following examples, without being limited thereto or thereby.

### EXAMPLE 1: PREPARATION OF SOLUTION OF POLYESTER POLYMER

Glycerol (1.0 kg, >99% purity) and citric acid (2.0 kg, >99% purity) were combined in a reactor vessel that was stirred and heated. Boric acid (9 g, 0.5 m/m, >99% purity) was added. Within approximately 15 minutes, the mixture was heated to 135° C. and kept at that temperature for 15 minutes. The mixture was then diluted using tap water, after which the water content was 40-50 wt. %. The mixture was allowed to cool down.

### EXAMPLE 2: MANUFACTURING OF A SEAT FOR A CHAIR

### Step 1: Preparing of the Hemp Mats

Four hemp mats were cut from a hemp roll (15×1 m, thickness of 10 mm, from Hempflax). The dimensions of the cut hemp mats were as depicted in FIG. 1.

### Step 2: Impregnation of the Hemp Mats

The four hemp mats were each impregnated with the resin obtained in Example 1. The resin was first sprayed evenly onto one side of the hemp mats. The hemp mats were then flipped and the other side of the hemp mats was sprayed with resin. The impregnation of the resin was done at room temperature. The total amount of resin sprayed onto the four mats was 40 wt. %, calculated on the amount of resin before dilution and the total weight of the four mats.

### Step 3: Pre-Curing of the Hemp Mats

The impregnated hemp mats were pre-cured at 105° C. for 30 mins. Then, they were allowed to cool down to room temperature. After they had cooled down, the four hemp mats were stacked on top of each other to create a structure having four layers of a composite material comprising hemp and polymer.

### Step 4: Pressing of the Hemp Mats

The structure was placed in a pre-heated mold (145° C.) that was coated with Teflon (to avoid sticking of the structure to the mold). A porous shell containing a number of parallel grooves, each comprising a number of pores was then placed on top of the structure. The porous shell contained pores with a diameter of 1.5 mm and had a pore density of 650 holes/m². The structure was then pressed for a total of 10 mins at a temperature of 145° C. (internal temperature of 115-125° C.). In this example, the pores in the porous shell aided the evaporation of water from the structure. No steam explosions occurred. The article was removed from the mold. The so-obtained article had a smooth and homogenous surface, as determined by touch and visual inspection of the number of cracks and the amount of areas not fully impregnated with resin.

### Step 5: After-Curing the Seat for a Chair

The article was then placed in an oven, pre-heated at 120° C. The chair was initially cured for 30 minutes at this temperature. No blistering on the surface of the chair was observed. Next, the chair was cured at 160° C. for 105 mins. The seat for a chair was then allowed to slowly cool down to room temperature.

The seat had an overall density of above 0.9 g/cm3, an extent of polymerisation of 0.85-0.95, and a water content of about 4 wt. %. The flexural strength was in the range of 50 MPa (in the trans-fiber direction) to 70 MPa (in the fiber direction).

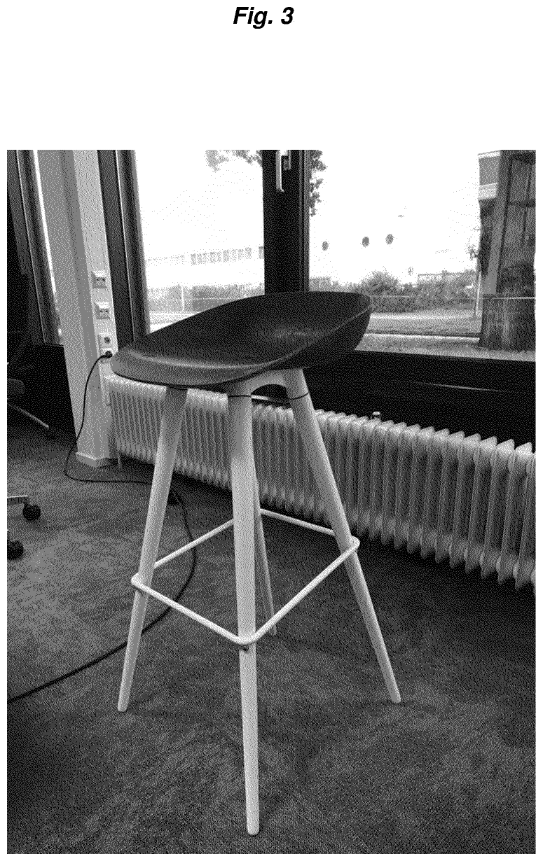

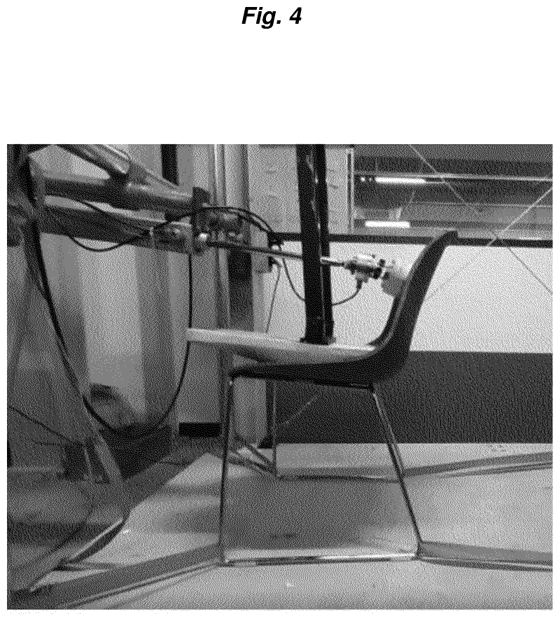

The seats were then turned into chairs using methods (and/or machining) known in the art. Chairs comprising a seat obtained using the process disclosed herein are shown in FIGS. 3 and 4.

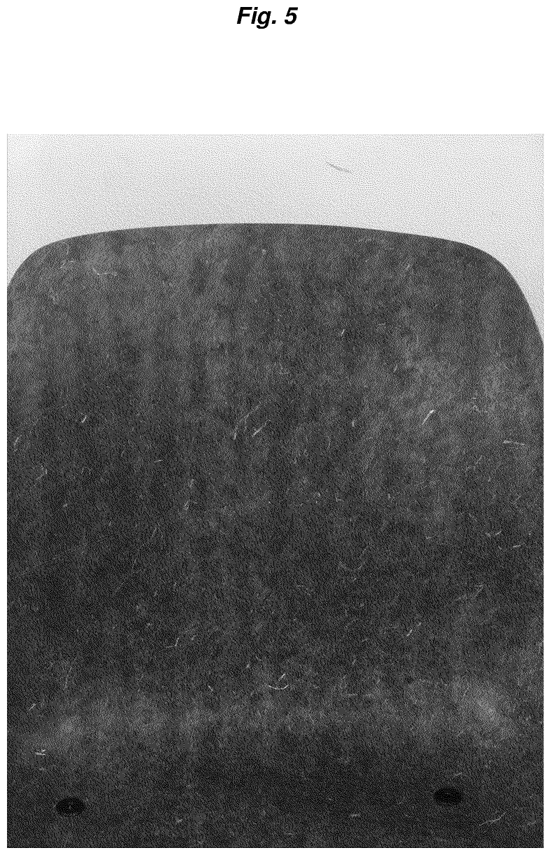

The resulting chair met industrial requirements for safety, strength, and durability. Specifically, it met the requirements of European standards EN 1728:2000, 6.2.1 and EN 1728:2000, 6.7. FIG. 4 shows the test set-up used in the industrial testing. FIG. 5 shows the back of the chair, after exposure to a force of 300 N for more than 100,000 cycles. As can be seen from the picture, no wear-and-tear from the testing could be observed. This is highly surprising, given the strain put on the chair during testing.

Moreover, no delamination was observed at any point in the process.

### EXAMPLE 3

### Step 1: Preparing of the Hemp Mats

Four hemp mats were cut from a hemp roll (15×1 m, thickness of 10 mm, from Hempflax). The dimensions of the cut hemp mats were as depicted in FIG. 1.

### Step 2: Impregnation of the Hemp Mats

The four hemp mats were each impregnated with the resin obtained in Example 1. The resin was evenly distributed over the surface one side of the hemp mats. The hemp mats were then flipped and pressure was applied on all mats with a rolling pin until all fibers in the mats were wetted. The impregnation of the resin was done at room temperature.

Step 3: Drying of the Hemp Mats

The impregnated hemp mats were dried at 40° C. for 12 hours. Then, they were allowed to cool down to room temperature. After they had cooled down, the four hemp mats were stacked on top of each other to create a structure having four layers of a composite material comprising hemp and polymer.

### Steps 4 and 5: Forming and After-Curing of the Hemp Mats

The structure was then formed and cured as described under Example 2, steps 4 and 5. As for the product of Example 2, the resulting product had an overall density of above 0.9 g/cm³, an extent of polymerisation of 0.85-0.95, and a water content of about 4 wt. %. The flexural strength was in the range of 50 MPa (in the trans-fiber direction) to 70 MPa (in the fiber direction).

The resulting non-flat article was processed to create a seat for a chair. The resulting seat was strong enough to withstand 190 kg (applied on the curved part of the back of the chair between the seat and the backrest) without breaking. No delamination was observed at any point during the process.

### EXAMPLE 4

### Step 1: Preparing of the Hemp Mats

Four hemp mats were cut from a hemp roll (15×1 m, thickness of 10 mm, from Hempflax). The dimensions of the cut hemp mats were as depicted in FIG. 1.

### Step 2: Impregnation of the Hemp Mats

The four hemp mats were each impregnated with the resin obtained in Example 1. The resin was evenly distributed over the surface one side of the hemp mats. The hemp mats were then flipped and pressure was applied on all mats with a rolling pin until all fibers in the mats were wetted. The impregnation of the resin was done at room temperature.

### Step 3: Drying Curing of the Hemp Mats

The impregnated hemp mats were dried at 40° C. for 12 hours and immediately subjected to the pre-curing step described in step 4.

### Step 4: Curing of the Hemp Mats

The dried impregnated hemp mats were pre-cured at 105° C. for 4 hours. The four hemp mats were then stacked on top of each other to create a structure having four layers of a composite material comprising hemp and polymer.

### Steps 5 and 6: Forming and After-Curing of the Hemp Mats

The structure was then formed and cured as described under Example 2, steps 4 and 5.

As for Example 2, the product had an overall density of above 0.9 g/cm³, an extent of polymerisation of 0.85-0.95, and a water content of about 4 wt. %. The flexural strength was in the range of 50 MPa (in the trans-fiber direction) to 70 MPa (in the fiber direction). The resulting seat for a chair was strong enough to withstand 190 kg (applied on the curved part of the back of the chair between the seat and the backrest) without breaking. No delamination was observed at any point during the process.

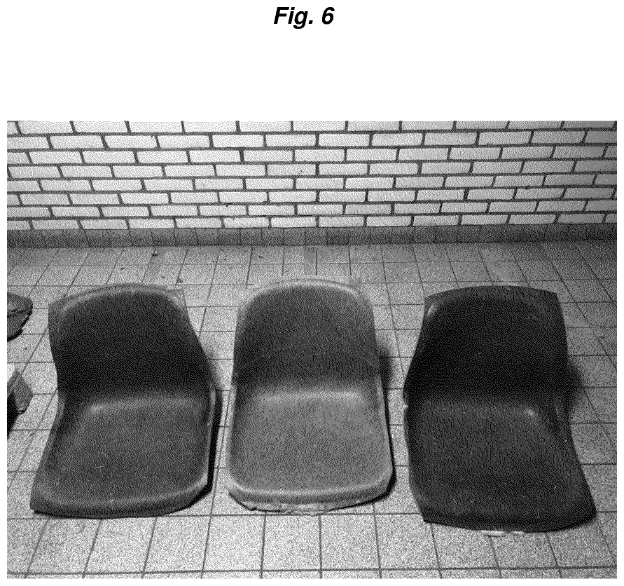

Intriguingly, Examples 2 to 4 result in seats for chairs with different colours, without addition of any colourants. Chairs obtained according to the processes described in Examples 2 to 4 are depicted in FIG. 6. The ability to control the colour of the non-flat article, without addition of any colourants, is a further improvement over conventional methods.

### EXAMPLE 5: GLASS FIBER FILLER

In this example, twill 2/2 woven glass fiber mats with an areal weight of 390 g/m² were used. The mats were woven from glass fibers with a linear density of 2.55 g/cm. Squares of 20 cm*10 cm glass fiber mats were cut using special scissors for fibres. The layers were weighted and impregnated with the resin of example 1. Then the mats were pre-cured at 80° C. for 45 minutes.

10 impregnated mats were stacked onto each other. The stack was placed in a hot press with a flat aluminium mould and an aluminium mould with a curved surface, resulting in the formation of non-flat products, and pressed at 15 kg/cm² for 20 minutes at 150° C. After pressing the sample was cured for one hour at 160° C. Solid and strong composite materials were obtained. The volumetric fibre fraction was 55%.

A Testometric M350-20CT testing bench was used to perform mechanical tests, giving a flexural strength of 191 MPa, flexural modulus of 14 GPa, and an interlaminar shear strength of 13.5 MPa.

### EXAMPLE 6: OTHER FIBERS

Using the method of example 5, composite products were manufactured from carbon fiber mats with an areal weight of 160 g/m2 and 3000 filaments per fiber in a twill 2/2 weave, the carbon fiber having a linear density of 1.76 g/cm. In addition to an attractive exterior, the resulting products showed good flexural strength, flexural modulus, and interlaminar shear strength

Experiments with woven aramid sheets also gave composites with good properties.

1. A process for manufacturing a non-flat article comprising steps of
providing a structure comprising a fibrous material and a resin comprising a polymer derived from an aliphatic polyalcohol with 2-15 carbon atoms and an aliphatic polycarboxylic acid that has an extent of polymerization of above 0 to 1.0, or the precursor monomers of the polymer, wherein the structure has a void fraction of 0.3-0.98 and a water content of below 40 wt. %, and
subjecting the structure to steps of:
if the extent of polymerization of the polymer of the strcture is below 0.5, polymerizing the polymer of the strcture to an extent of polymerization of 0.5-1,
pressing the structure to reduce the void fraction, and to an
forming the structure into a non-flat article by applying a force at an internal temperature above a glass transition temperature (T_{g}) of the polymer, wherein the resulting non-flat article having an extent of polymerisation of at least 0.5 and a water content of less than 20 wt. %,
wherein the polymerisation step if carried out, the pressing step to reduce the void fraction, and forming step are carried out simultaneously; the polymerisation step, if carried out and the pressing step to reduce the void fraction are carried out simultaneously, followed by the forming step; the polymerisation step, if carried out, and the pressing step to reduce the void fraction are carried out sequentially in any order, followed by the forming step; or the polymerisation step, if carried out, is followed by the pressing step to reduce the void fraction and forming step, with the forming step being carried out simultaneously with the pressing step to reduce the void fraction or subsequent to the pressing step to reduce the void fraction.

2. The process according to claim 1, wherein the polymerisation step, if carried out, the pressing step to reduce the void fraction, and the forming step are carried out simultaneously.

3. The process according to claim 1, wherein the structure has a void fraction of 0.4-0.98.

4. The process according to claim 1, wherein the fibrous material contains fibers having a fiber length of 1-10 cm.

5. The process according to claim 1, wherein the structure has a polymer content of 20-70 wt. %, based on a total weight of the fibrous material and the polymer.

6. The process according to claim 1, wherein, during the forming step, water is evaporated through a plurality of holes.

7. The process according to claim 1, further comprosing, after the forming step, a first curing step of curing the non-flat article at an internal temperature of at least 80° C.

8. The process according to claim 1, wherein the fibrous material is selected from the group consisting of hemp, flax, cotton, kenaf, jute, ramie, sisal, coconut, hair, wool, silk and fibers derived from feathers, viscose, glass, polyesters, carbon, aramids, nylons, acrylics, polyolefins and mixture thereof.

9. The process according to claim 1, wherein the aliphatic polyalcohol is selected from the group consisting of 1,2-propanediol 1,3-propanediol, and 1,2-ethanediol, glycerol, sorbitol, xylitol, mannitol and mixture thereof; and/or
the aliphatic polycarboxylic acid comprises one or more acids selected from the group consisting of citric acid, isocitric acid, cis-aconitic acid, trans-aconitic acid, and 3-carboxy-cis,cis-muconic aicd.

10. The process according to claim 1, wherein the non-flat article is a part for a piece of furniture.

11. A structure suitable for use in the process of claim 1 comprising a fibrous material impregnated with resin comprising a polymer derived from an aliphatic polyalcohol with 2-15 carbon atoms and an aliphatic polycarboxylic acid, wherein the structure has a void fraction of 0.3-0.98, the polymer has an extent of polymerisation of 0.5-0.8, and the structure has a water content of less than 20 wt. %.

12. A non-flat at article obtainable by the process according to claim 1, wherein the non-flat article has a flexural strength greater than 20 MPa, as determined using ASTM D 7264.

13. A non-flat article comprising a fibrous material impregnated with resin comprising a polymer derived from an aliphatic polyalcohol with 2-15 carbons and an aliphatic polycarboxylic acid, the polymer having an extent of polymerisation of at least 0.5, and the non-flat article having a water content less than 20 wt. % and, a flexural strength greater than 20 MPa, as determined using ASTM D 7264.

14. The non-flat article according to claim 12, wherein the structure has a void fraction of 0.8 or less, and/or a density of at least 0.7 g/cm³ and/or a water content of less than 10 wt. %, and/or or contains a polymer derived from an aliphatic polyalcohol with 2-15 carbons and an aliphatic polycarboxylic acid with an extent of polymerisation of at least 0.6.

15. The non-flat article according to claim 13, wherein the non-flat article is a part for a piece of furniture.

16. The process according to claim 1, wherein the structure has a void fraction of 0.7-0.95.

17. The process of claim 7, wherein the first curing step is carried out for a period of at least 15 minutes.

18. The process of claim 7, further comprising, after the first curing step, a second curing step wherein the non-flat article is cured at an internal temperature of 140-220° C.

19. The process of claim 7, wherein the second curing step is carried out for a period of at least 60 minutes.

20. The non-flat article according to claim 12, wherein the structure has a void fraction of 0.2 or less, a density of at least 0.7 g/cm³, a water content of less than 10 wt. %, and contains a polymer derived from an aliphatic polyalcohol with 2-15 carbons and an aliphatic polycarboxylic acid with an extent of polymerisation of at least 0.8.
